(19) United States
(12) Patent Application Publication
(10) Pub. No.: US 2022/0371921 A1
(43) Pub. Date: Nov. 24, 2022

(54) LIQUID DISINFECTING MODULE

(71) Applicant: STRAUSS WATER LTD, Or-Yehuda (IL)

(72) Inventors: Haim WILDER, Raanana (IL); Liron ALMISHALI, Petach Tikva (IL); Haya SANDORI KAZAZ, Gedera (IL); Moshe ELIYAHU, Nechusha (IL)

(21) Appl. No.: 17/794,290

(22) PCT Filed: Dec. 21, 2020
(86) PCT No.: PCT/IL2020/051316

§ 371 Date: Jul. 21, 2022

Related U.S. Application Data
(60) Provisional application No. 62/964,358, filed on Jan. 22, 2020.
(60) Provisional application No. 62/981,637, filed on Feb. 26, 2020.

(51) Int. Cl. C02F 1/32

(52) U.S. Cl. CPC C02F 1/325; C02F 2303/04; C02F 2201/3228; C02F 2201/3222; C02F 2307/06; C02F 2307/10

(57) ABSTRACT

The present disclosure concerns module for disinfecting water by UV radiation, for example source or miming water to be disinfected for the purpose of serving as drinking water. In particular, the present disclosure provides a UV-LED radiation-based modules for disinfecting water before consumption, the modules include at least one removable lens for prolonging the service life of the module.

### TECHNOLOGICAL FIELD

The present disclosure concerns a module for disinfecting liquids by UV radiation, for example source or running water to be disinfected for the purpose of serving as drinking water.

### BACKGROUND ART

References considered to be relevant as background to the presently disclosed subject matter are listed below:
U.S. Pat. No. 7,645,381
WO 2011/051708
U.S. Pat. No. 8,481,971
U.S. Pat. No. 9,855,363
U.S. Pat. No. 10,221,080
U.S. Pat. No. 6,767,453

Acknowledgement of the above references herein is not to be inferred as meaning that these are in any way relevant to the patentability of the presently disclosed subject matter.

### BACKGROUND

Water cooling machines and other dispensing apparatus are generally required to dispense water which is purified and potable. Ultraviolet (UV) systems are often used to purify water. These work by irradiating the water with UV radiation which destroys bacteria and other microorganisms.

Common UV radiation sources in water dispensers are typically mercury lamps, which have a relatively short life-span and are considered to be of lesser safety to users. Hence, there is a need to provide UV disinfection solutions that are safer to use and have a relatively long life-span.

In addition, whilst water coolers and similar dispensing machines used in domestic, office or factory environments purify water to a sufficient level to be drinkable and destroy microorganisms present in the water that is received from a source, removal or destruction of microorganisms at the actual dispensing point or faucet has proved to be problematic; as typically no purification means are provided onto the faucet or the dispensing point, contamination of the water may occur. The wet environment at the dispensing point or faucet may also be sufficient to support undesired microorganisms proliferation. Thus, water which have been treated and purified may be contaminated at the point of dispensing.

### GENERAL DESCRIPTION

Provided by this disclosure is a module for disinfecting water within a water dispenser or at the point of dispensing by utilizing a UV radiation source. The UV-radiation disinfection modules of this disclosure comprise one or more UV radiation sources, typically UV light emitting diodes (UV-LED), which have a relatively long life-span (significantly longer than standard mercury lamps), and are hence replaced at relatively large time intervals, thus requiring less maintenance of the water dispenser. Further, UV-LED lamps are considered safer to the user, require less energy input for their operation and can be operated at lower voltages.

Due to their long service life, however, care should be taken to maintain disinfection effectiveness throughout the lifespan of the UV radiation source. When disinfecting water, prolonged and constant contact of the module parts with water can cause sedimentation and/or cloudiness over UV-transmissive parts of the UV-radiation disinfection module, thereby reducing its effectiveness. In order to mitigate this, the modules of this disclosure utilize replaceable lenses, which can be easily and safely replaced by the user without the need to replace the entire UV-radiation disinfection module.

Thus, in one of its aspects, the disclosure provides a UV-radiation disinfection module for disinfecting water, the module comprises at least one disinfection chamber and at least one UV radiation unit. The disinfection chamber extends along a longitudinal axis, and has at least one water inlet and at least one treated water outlet with a water flow path defined therebetween. The disinfection chamber is configured to permit exposure of the water to UV radiation during flow of water along the flow path, the UV radiation being emitted from a UV radiation source located in the UV radiation unit. The UV radiation unit comprises at least one UV radiation source, and one or more lenses positioned between the UV radiation source and the disinfection chamber for focusing UV radiation from the UV radiation source into the disinfection chamber, at least one of the one or more lenses being a user-removable lens, removably received in the UV radiation unit.

In other words, between the UV radiation source and the disinfection chamber, there is positioned at least one lens that refracts UV radiation from the radiation source and focuses the UV radiation to the water flowing along the flow path defined in the disinfection chamber. As the lens can come into contact with water flowing through the module, the lens can become cloudy or water-originating sediments can accumulate on the lens over time, thus the lens is user-removable from the module, such that it can be easily replaced by the user without requiring to extract the entire UV-radiation disinfection module from the apparatus in which it is installed. This, in turn, ensures that efficient radiation treatment is obtained in the water throughout the relatively long service time of the UV radiation source. The removable lens actually functions both to focus UV radiation into the water as it flows through the module, as well as to physically separate between the UV radiation module and the disinfection chamber. Such physical separation enables to isolate the UV radiation unit (‘dry’ environment) from the water flowing through the disinfection chamber (‘wet’ environment).

In some embodiments, the removable lens can be displaced along an extraction axis, perpendicular to the longitudinal axis, between a functional position in which the lens is received within the UV radiation unit and positioned between the UV radiation source and the disinfection chamber, and a non-functional position, in which the removable lens is extracted from the UV radiation unit. In such a manner, a user can simply pull the lens out of the UV radiation unit and clean it or replace it by a new lens without requiring taking apart the UV-radiation disinfection module or without taking the entire module out of the device/apparatus in which it is installed.

The removable lens is at least partially UV-transmissive in order to permit transmission of at least a portion of the UV radiation emitted from the UV radiation source into the water. By some embodiments, the removable lens may have an optical magnification of between about 0% to 500%.

The module may further comprise at least one stationary lens, that is positioned within the UV radiation module between the user-removable lens and said UV radiation source. The stationary lens can be used to provide an initial refraction, filtration and/or focusing of the UV radiation emitted from the UV radiation source, before passing through the removable lens.

Each of the lenses can have any applicable shape or geometry, e.g. planar, curved, semi-sphere, concave, convex, bi-focal, of symmetrical or a-symmetrical curvature, etc., as long as the desired focusing of UV radiation is obtained thereby.

In some embodiments, the at least one UV radiation source is a UV-LED (ultraviolet light emitting diode). The UV radiation unit can comprise one or more UV-LED.

It is to be noted that the lens(es) can be made of UV radiation-transmissive material, that determines the desired wavelength of radiation to be irradiated into the water for obtaining sufficient radiation transmitted into the disinfection chamber to effectively disinfect the water flowing therein. For example, the lens(es) can be made of quartz.

By some embodiments, the at least one water inlet of the disinfection chamber is positioned proximal to a first end thereof, and the at least one treated water outlet is positioned proximal to the opposite second end of the disinfection chamber. Typically, the UV radiation unit and the disinfection chamber extend along a mutual longitudinal axis, such that the at least one UV radiation source is typically positioned at said second end.

In order to increase the efficiency of UV radiation activity in the water, by some embodiments, the disinfection chamber may comprise one or more mirror elements, fitted at the first end, for reflecting UV radiation into the disinfection chamber.

The disinfection chamber may further comprise a UV-reflecting liner coating at least a portion of the internal surface of the disinfection chamber in order to reflect radiation back into the water.

Another means to increase efficacy of the UV radiation activity is by configuring the disinfection chamber to increase transmittance of the UV radiation into the water and/or modify the flow of water along the flow path in order to increase exposure of water to UV radiation.

For example, the disinfection chamber can be generally cylindrical, and having one or more narrowing sections. The narrowing section(s) change the flow profile of water along the flow path, thereby causing local region(s) along the flow path in which radiation can be focused on relatively small volumes of water.

In another embodiment, the disinfection chamber is cylindrical, and has an axial hollow bore formed out of co-axial frustoconical cavities, consecutively arranged along the longitudinal axis, with their narrow ends being integral one with the other to form a narrowing point. In other words, the hollow bore has a shape similar to an hourglass. The focal point of the removable lens may, in such embodiments, coincide with the point of the narrowing point.

By other embodiments, the disinfection chamber encases an internal sleeve, co-axial with the disinfection chamber, for example having the shape of an hourglass to form a narrowing point. By another arrangement, the internal sleeve has the shape two co-axial frustoconical tubes, consecutively arranged along the longitudinal axis, with their narrow ends being integral one with the other to form a narrowing point. The focal point of the removable lens may coincide with the point of the narrowing point to increase UV radiation efficacy in the water.

The internal sleeve may be made of or coated by a UV-reflective material.

In order to permit further maintenance of the UV-radiation disinfection module, the disinfection chamber may be detachably attached to the UV radiation unit. Hence, a user can detach the disinfection chamber from the UV radiation unit for cleaning it or replacing it (e.g. in case sedimentation of contaminants has occurred within the chamber over time).

As the UV radiation source produces heat that typically needs to be removed, the UV radiation unit may comprise at least one fluid-flow passage configured to pass a cooling fluid through the unit. In some embodiments, the cooling fluid may be an aqueous or a non-aqueous liquid. In other embodiments, the cooling fluid is gas, e.g. air.

In further embodiments, the cooling fluid is water. The fluid-flow passage can be fed with cooling fluid from a cooling fluid reservoir. Alternatively, water that is used as a cooling fluid can then be fed into the disinfection chamber for disinfection and dispensing.

Hence, by another aspect of this disclosure, there is provided a UV-radiation disinfection module for disinfecting water, comprising a UV radiation unit and a disinfection chamber integral therewith and extending along a longitudinal axis defined therebetween, and a liquid conduit forming liquid communication between the UV radiation unit and the disinfection chamber; the UV radiation unit comprises a housing with a water inlet located at a bottom section of the housing and a water outlet located at a side wall of the housing and forming a first liquid flow path therebetween, and a UV radiation source assembly housed within the housing; formed within the UV radiation source assembly is a liquid sealed chamber that houses one or more UV radiation sources, and the UV radiation source assembly comprises at least one user-removable lens positioned between the UV radiation source and the disinfection chamber for focusing UV radiation from the UV radiation source into the disinfection chamber, the removable lens being removably received in the UV radiation unit; the one or more UV radiation sources being coupled to a heat sink positioned at the bottom of the liquid sealed chamber, such that the heat sink is thermally coupled to the first flow path thereby heat is removed from the heat sink by the water flowing through the first flow path; the disinfection chamber having a chamber inlet and a chamber outlet defining a second liquid flow path therebetween, and the disinfection chamber having an internal face along the second liquid flow path with at least a portion thereof covered by a reflective surface such that UV radiation from the UV radiation source is reflected by the reflective surface into the water flowing in the second flow path thereby disinfecting the water; the liquid conduit formed between the water outlet of the UV radiation unit and the chamber inlet of the disinfection chamber, thereby forming the liquid communication between the radiation unit and the disinfection chamber.

In other words, in another one of its aspects, the disclosure provides a module for disinfecting a liquid (e.g. water), the device comprising a UV radiation unit, a disinfection chamber integral therewith and a liquid conduit forming liquid communication between the UV radiation unit and the disinfection chamber. The UV radiation unit and the disinfection chamber extend along a common longitudinal axis. The UV radiation unit comprises a housing with a water inlet located at a bottom section of the housing and a water outlet located at a side wall of the housing and forming a first liquid flow path therebetween. A UV radiation source assembly is housed within the housing, and has a liquid sealed chamber formed therein. The liquid sealed chamber houses one or more UV radiation sources, which are coupled to a heat sink positioned at the bottom of the liquid sealed chamber, such that the heat sink is thermally coupled to the first flow path.

As the UV radiation unit and the disinfection chamber are integral with one another, the UV radiation unit and the disinfection chamber are separated by at least one user-removable lens, such that radiation emitted from the UV radiation source can be transmitted and/or refracted into the disinfection chamber through the removable lens.

The disinfection chamber has a chamber inlet and a chamber outlet defining a second liquid flow path therebetween, and has an internal face along the second liquid flow path with at least a portion thereof covered by a reflective surface such that UV radiation from the UV radiation source is reflected by the reflective surface into the water flowing in the second flow path, thereby disinfecting the water.

The liquid conduit is formed between the liquid outlet of the UV radiation unit and the disinfection chamber's inlet, thereby forming the liquid communication between the radiation unit and the disinfection chamber.

It is noted that the term heat sink refers within the context of the present disclosure to a passive heat exchanger that removes the heat generated by the radiation source (and/or electronic components associated therewith) to a fluid (e.g. liquid) medium, thereby allowing regulation of the device's temperature at optimal levels. In some embodiments, the heat sink is cooled by water as it flows in the first flow path (and from there into the second flow path).

The removable lens is positioned between the UV radiation source and the disinfection chamber, and permits focusing of the UV radiation emitted from the UV radiation source into the water flowing in the second liquid flow path, thus disinfecting the water. As noted, in some embodiments, the removable lens can be displaced along an extraction axis, perpendicular to the longitudinal axis, between a functional position in which it is received within the UV radiation unit and positioned between the UV radiation source and the disinfection chamber, and a non-functional position, in which it is extracted from the UV radiation unit.

As also noted, the module may further comprise at least one stationary lens, that is positioned within the UV radiation module between the user-removable lens and said UV radiation source.

In order to regulate or control the liquid flowing rate within the disinfecting chamber, various arrangements can be utilized, without significantly hindering the radiation treatment efficacy, as already discussed hereinabove.

For example, the disinfection chamber may be cylindrical, with one or more narrowing sections; or may have an axial hollow bore formed out of co-axial frustoconical cavities, consecutively arranged along the longitudinal axis, with their narrow ends being integral one with the other to form a narrowing point (in such embodiments, the focal point of the lens may coincide with the point of the narrowing point).

Alternatively, the disinfection chamber may encase an internal sleeve, co-axial with the disinfection chamber, which may have the shape of an hourglass to form a narrowing point (i.e. with two co-axial frustoconical tubes, consecutively arranged along the longitudinal axis, with their narrow ends being integral one with the other to form a narrowing point).

In one exemplary embodiment, the internal face of the disinfecting chamber may be lined with a radiation-transmissive lining, e.g. a quartz tube. By controlling the geometry, length and radius of the tube, various flow rates can be obtained, thereby controlling the period of time at which the liquid is exposed to the radiation as it flows through the second flow path.

In another exemplary embodiment, the disinfection chamber comprises two or more tubes made of radiation-transmissive material and extending along the disinfection chamber, each being in liquid communication with the disinfection chamber inlet and the disinfection chamber outlet, such that each of the tubes constituted a second liquid flow path. Utilizing two or more such tubes increases the surface area exposed to the radiation. Similarly, changing the geometry, length and radius of the tubes, enables controlling the flow rate and radiation exposure duration.

By another exemplary embodiment, the disinfection chamber further comprises a horizontal plate, axially spaced-apart from said top wall of the liquid sealed chamber and forming a partition of the disinfection chamber, the horizontal plate being made of a radiation-transmissive material and having at least one orifice for controlling the flow of liquid through the disinfection chamber. The orifice(s) is (are) located at the focal point(s) of the radiation source(s) hence ensuring that the flowing liquid absorbs a maximum amount of radiation.

The disinfection module of this disclosure may be incorporated into a water dispensing device. In such embodiments, the water inlet is configured to establish liquid communication with a water source for feeding water into the dispensing device, and/or the disinfection chamber outlet is configured to establish liquid communication with a dispensing outlet of a water dispenser.

Hence, by another aspect, there is provided a beverage dispenser comprising at least one UV-radiation disinfection module as described herein.

In some embodiments, the beverage is water.

The disinfection modules of this disclosure may also be incorporated into any liquid, typically water, supply line in which disinfecting is required. In one embodiment, the module may be configured for fitting at or near a dispensing outlet of a water dispensing device. In such embodiments, the water inlet is configured to establish liquid communication with a water source for feeding water into the module, and/or the disinfection chamber outlet is configured to establish liquid communication with a dispensing outlet of a water dispenser, and/or a spout.

By another embodiment, the disinfection module may be integral with a spout unit to be fitted onto a main or domestic water supply line.

By another aspect of this disclosure, there is provided a UV-radiation disinfection module for disinfecting water as disclosed herein, being configured for fitting into a pressurized water supply line, e.g. into a municipal pressurized water supply system or the pressurized water system of a house or a building. Once fitted into the water supply line, source water flowing through the module undergo UV disinfection, such that disinfected water are dispensed at the user's end.

The module may be fixedly (i.e. permanently) linked to the water supply line. In another arrangement, the module may be detachably linkable to one or both of a water source and a dispensing device/spout, such that a user can detach the module and remove it from the water supply line, e.g. for replacing the module or for maintenance purposes. Such detachable link may be in any suitable form known per se, for example by a screw-fitting, snap-fitting, bayonet coupling, etc.

In another arrangement, the module is provided with a water-spout that functions to dispense the disinfected water, similar to a standard house-hold spout, and is linkable as an add-on unit to a water supply line. Thus, in another aspect, this disclosure provides a liquid (e.g. water) spout unit for fitting onto a water outlet of a water supply line, that comprises a UV-radiation disinfection module for disinfecting water as described herein and a spout linked to the outlet of the module.

The spout may be integrally formed with the module, such that the unit is provided as an add-on unit to be assembled onto a water supply line, e.g. replacing the standard household water spout. In other arrangements, the spout is detachably attachable to the module.

Further, there is provided a kit comprising a module as described herein and a spout unit detachably attachable thereto.

In some embodiments, UV radiation unit in the module included in the kit comprises at least one removable lens positioned between the UV radiation source and the disinfection chamber for focusing UV radiation from the UV radiation source into the disinfection chamber, and the kit further comprises one or more such removable lenses.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a longitudinal cross-section through a UV-radiation disinfection module according to an embodiment of this disclosure.

FIG. 2A shows an isometric view of a UV-radiation disinfection module according to another embodiment of this disclosure; FIG. 2B shows a longitudinal cross section of the module of FIG. 2A; FIG. 2C shows the cross section of FIG. 2B, showing the water flow path through the module; FIG. 2D shows the embodiment of FIG. 2B, however with an internal hourglass-shaped sleeve.

FIGS. 3A-3B are isometric and longitudinal cross-sectional views, respectively, of a UV-radiation disinfection module according to a configuration of the module of FIGS. 2A-2D.

FIG. 4 shows a longitudinal cross section through a module according to another embodiment of this disclosure.

FIG. 5 shows a longitudinal cross-sectional view of a further embodiment of the module of this disclosure.

FIG. 6A is a perspective view of a water dispenser comprising a UV-radiation disinfection module according to this disclosure.

FIG. 6B is a longitudinal cross section through the dispenser unit of FIG. 6A.

FIG. 7A is a perspective view of a spout unit that comprises a module according to an embodiment of this disclosure.

FIG. 7B is a longitudinal cross section through the spout unit of FIG. 7A.

### DETAILED DESCRIPTION OF EMBODIMENTS

In the following, the present disclosure will be elaborated and illustrated through description of some specific embodiments with reference to the annexed drawings. It is to be understood that the figures are intended to exemplify the general principles of this disclosure and are not to be construed in any way to be limiting.

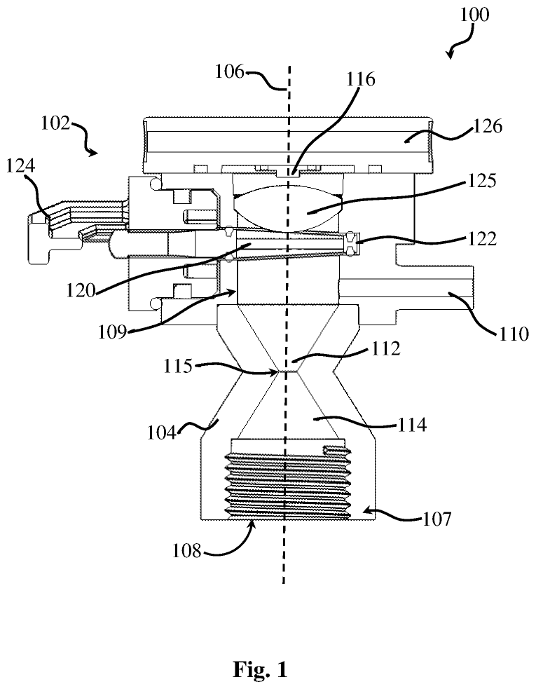

Referring first to FIG. 1, shown are longitudinal cross-sections through a UV-radiation disinfection module according to an embodiment of this disclosure. Module 100 includes a UV radiation unit 102 and a disinfection chamber 104, arranged along a longitudinal axis 106 of module 100. The disinfection chamber 104 comprises a water inlet 108 (located at a first end 107 of the disinfection chamber), and a treated water outlet 110 (located at a second end 109 of the disinfection chamber), with a water flow path 112 defined therebetween. In order to regulate flow of water through the disinfection chamber, as well as to create an area in which the volume of water is reduced to enable increased efficiency of UV disinfection, chamber 104 of in this example has an internal, hourglass-shaped cavity 114. The narrowing of the flow path 115 changes the flow profile of water along the flow path, thereby causing local region(s) along the flow path in which radiation can be focused on relatively small volumes of water. The cavity 114 is typically lined or coated by a UV-reflective material, hence causing reflections of the UV light rays, and increasing exposure of the water to UV radiation along the flow path.

Although in this specific example the narrowing of the flow path is provided the shape of the cavity of the chamber, it is to be understood that the chamber can have a cylindrical shape, and comprise an hourglass shaped internal sleeve made of or coated by UV-reflecting material (not shown).

UV radiation unit 102 includes a UV-LED radiation source 116 which is configured to irradiate UV radiation into the disinfection chamber 104 during flow of water along the flow path 112. While in this specific example only a single UV-LED radiation source is shown, it is to be understood that more than a single UV-LED source can be utilized. In order to focus the UV radiation into the flowing water, one or more lenses can be positioned between the UV radiation source 116 and the disinfection chamber 104. User-removable lens 120 is positioned between the UV-LED radiation source 116 and the disinfection chamber 104, such as to form a physical barrier between the UV radiation module and the disinfection chamber. As lens 120 typically comes into contact with the water flowing through the module, it is removably received within the UV radiation module. In this specific example, the lens 120 is held in position within a groove 122, and can be displaced out of the groove by pulling onto handle 124, that is associated with the lens, in order to remove the lens out from module 100. This enables replacement of the removable lens or cleaning thereof when needed, permitting a user to replace the lens whenever required in order to maintain efficiency of UV radiation transmittance through the lens throughout the service life of the module.

The removable lens 120 typically has optical magnification of between about 0% and 500%.

In this specific example, the UV radiation module further comprises a stationary lens 125, which can function to provide initial or preliminary focusing of the UV radiation emitted from the source 116. It is to be understood, however, that in other configurations (not shown), this stationary lens is optional.

Formed in the UV radiation unit 102 is also a fluid-flow passage 126 through which a cooling fluid, such as water or air can be provided, permitting disposing of the heat formed by the UV-LED source 116 during operation of the module.

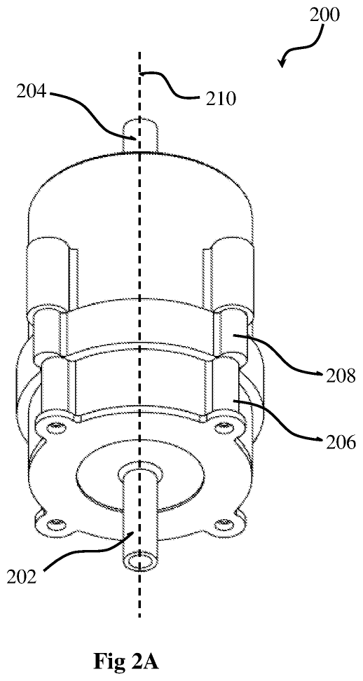

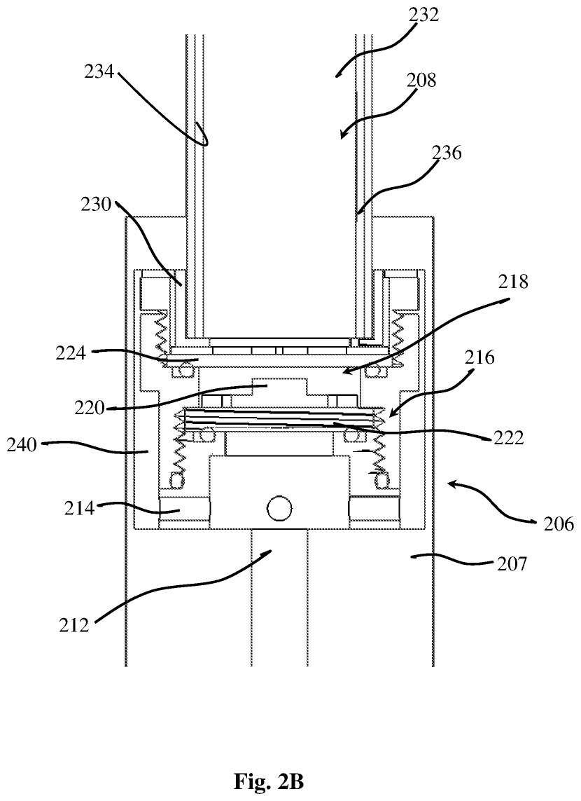

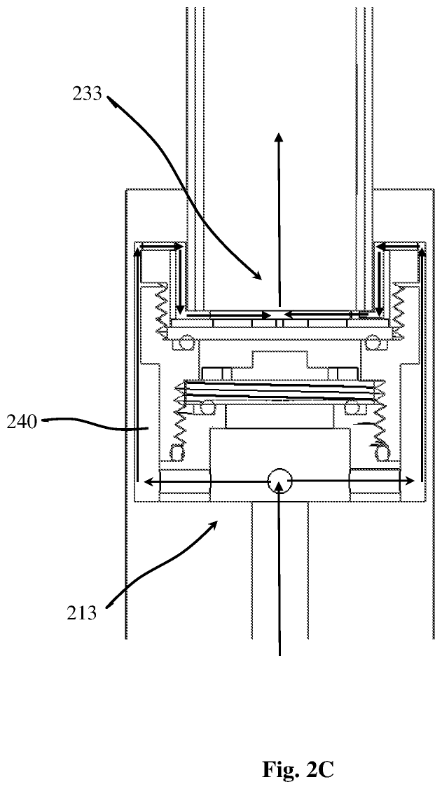

Another configuration of the UV-radiation disinfection module is shown in FIGS. 2A-2D. Module 200 has a module water inlet 202, a water module outlet 204, a radiation unit 206 and a disinfection chamber 208, with a longitudinal axis 210 extending between the inlet 202 and the outlet 204.

The description below makes occasional reference to a top or bottom, and is to be referred to with respect to longitudinal axis 210. It is to be understood that this is done for convenience of description only. As can be appreciated in use the orientation has no functional significance and it may be coupled to the appliance or system in any desired orientation according to various engineering or other considerations.

Radiation unit 206 comprises a housing 207 with a water inlet 212, fluidly linked to water module inlet 202 and located at a bottom section of the housing and a water outlet 214 located at a side wall of the housing and forming a first liquid flow path 233 therebetween (seen in FIG. 2C). A UV radiation source assembly, generally designated 216, is housed within the housing 207, and has a liquid sealed chamber 218 formed therein. The liquid sealed chamber 218 houses one or more UV radiation sources 220 (e.g. UV-LED devices), which are coupled to a heat sink 222 positioned at the bottom of the liquid sealed chamber. As the heat sink is thermally coupled to the first flow path, heat can be removed from the heat sink by the water flowing through the first flow path.

Separating between the liquid sealed chamber 218 and the disinfection chamber 208, is a user-removable lens 224, made of a UV radiation-transmissive material, e.g. quartz, to enable radiation emitted from the UV-LED 220 to be transmitted and focused into the disinfection chamber 208.

The disinfection chamber has a chamber inlet 230 and a chamber outlet 232 (fluidly linked to water module outlet 204) defining a second liquid flow path 231 therebetween (better seen in FIG. 2C). The disinfection chamber has an internal face 234 along the second liquid flow path with at least a portion thereof covered by a reflective surface 236 such that UV radiation from the UV radiation source is reflected by the reflective surface into the water flowing in the second flow path thereby disinfecting the water.

A water conduit 240 is formed between the water outlet 214 and the chamber inlet 230, thereby forming the liquid communication between the radiation unit 206 and the disinfection chamber 208.

As can be seen in FIG. 2D, chamber 208 can also incorporate an hourglass internal sleeve 242 (which can be made of or coated by a UV-reflective material), in order to control and direct the water flow through the disinfection chamber and permit focusing of radiation into relatively small volumes of water flowing through the narrowing formed by the internal sleeve.

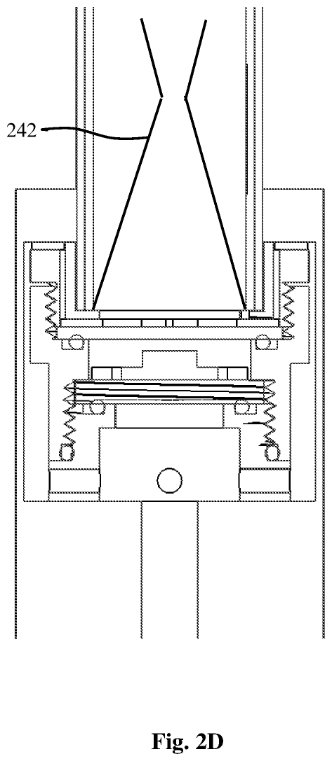

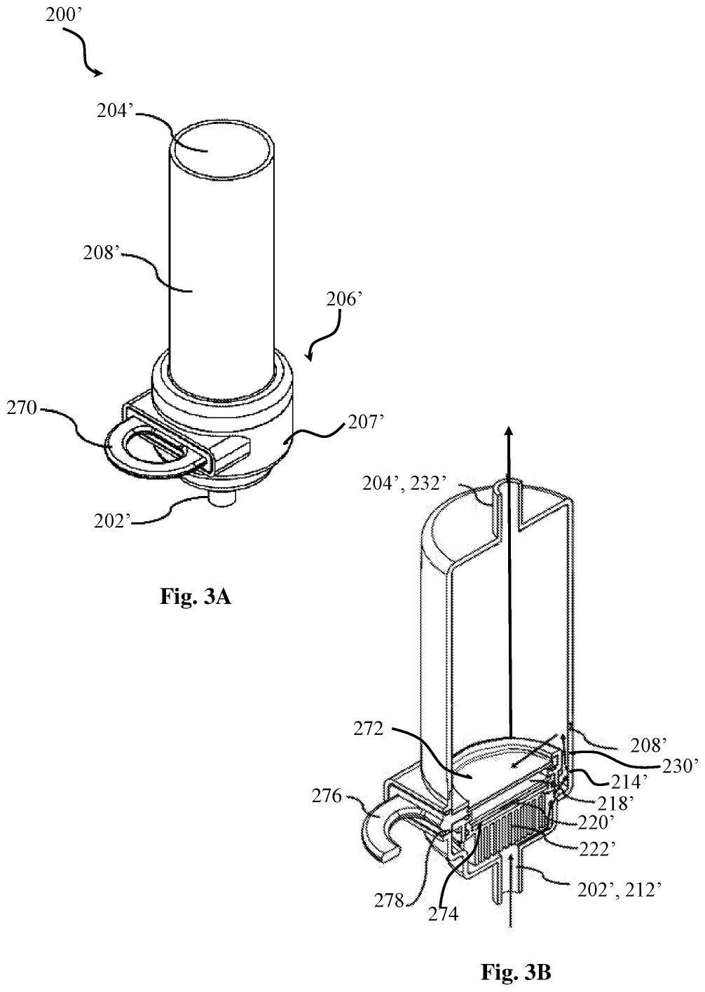

Another configuration of the module is shown in FIGS. 3A-3B, showing a module 200′ similar to that of FIGS. 2A-2D, however including a replaceable lens. Module 200′ has a module water inlet 202′, a water module outlet 204′, a UV radiation unit 206′ and a disinfection chamber 208′, and a replaceable lens assembly 270.

Radiation unit 206′ comprises a housing 207′ with water module inlet 202′ functioning also as water inlet 212′ and located at a bottom section of the housing and a water outlet 214′, forming a first liquid flow path therebetween. UV-LED 220′ is housed within the housing 207′, within a liquid sealed chamber 218′ formed between lens 272 a heat-conductive separation plate 274 (plate 274 separating between the heat sink 222′ and the UV-LED 220′). The UV-LED 220′ is coupled to the heat sink 222′ through the separation plate 274, such that flow of water through the first flow path removes heat from the heat sink.

Water then flows through a second flow path, defined between chamber inlet 230′ and a chamber outlet 232′ (also functioning as module outlet 204′), and disinfected by the UV radiation during its flow through the disinfection chamber.

Lens module 270 comprises removable lens 272 and handle 276. The lens 272 is removably received within a groove or slot 278, such that a user can remove the lens when replacement thereof is needed.

FIG. 4 shows another embodiment of a module 300 according to this disclosure. The device of FIG. 4 is similar to the device of FIGS. 2A-3B, hence, elements having the same functionality were given like numerals shifted by 100. For example, inlet 302 in FIG. 4 has the same function as inlet 202 in FIGS. 2A-2D. The reader is referred to the description above for a detailed description of these elements.

In module 300, the internal face of the disinfection chamber 308 is lined with a radiation-transmissive lining, in this case a quartz tube 350. By proper design, tube 350 elongates liquid motion within the chamber 308, resulting in a longer exposure of the liquid to the radiation, and “forces” liquid to flow within the focal point of the radiation source 320 hence ensuring a desired predetermined antimicrobial treatment of the water. It is to be understood that while only one tube 350 is shown, it is also contemplated within the scope of this disclosure that two or more such tubes can be utilized, each being in liquid communication with the disinfection chamber inlet and the disinfection chamber outlet, such that each of the tubes constituted a second liquid flow path, thus further increasing the surface area exposed to the radiation.

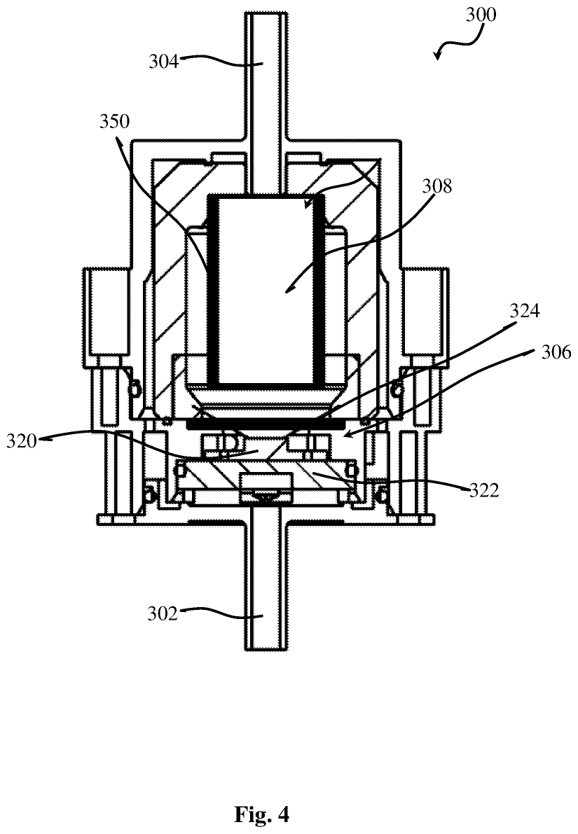

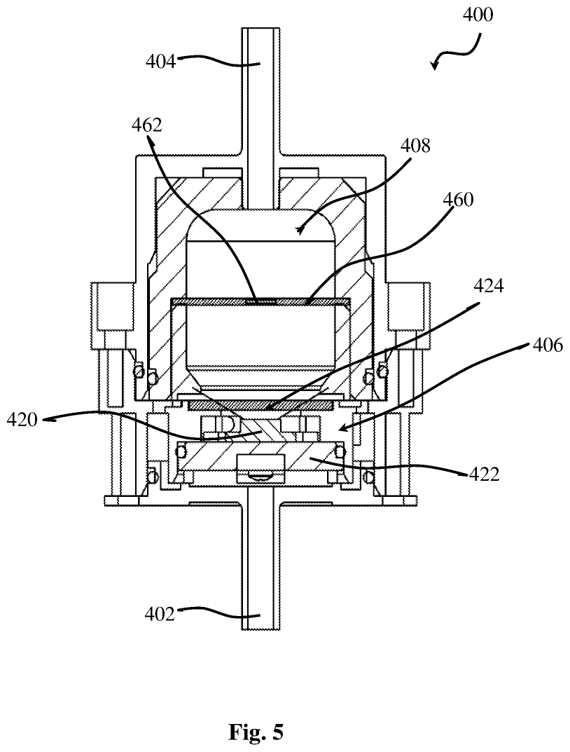

FIG. 5 shows another embodiment of a module 400 according to this disclosure. The module of FIG. 5 is similar to the device of FIGS. 2A-2D, hence, elements having the same functionality were given like numerals shifted by 200. For example, inlet 402 in FIG. 5 has the same function as inlet 202 in FIGS. 2A-2D. The reader is referred to the description above for a detailed description of these elements.

In module 400, the disinfection chamber 408 comprises a horizontal plate 460, axially spaced-apart from the removable lens 424, and forms a partition of the disinfection chamber. The horizontal plate 460 is typically made of a UV radiation-transmissive material, e.g. quartz, and has at least one orifice 462 for controlling the flow of liquid through the disinfection chamber. The orifice 462 is located at the focal point of the radiation source 320 hence ensuring that the flowing liquid absorbs a maximum amount of radiation.

As noted, the UV-radiation disinfection module of this disclosure may be linkable to various end units, such as liquid dispensers and spouts for dispensing disinfected liquid. The module may be configured for temporary association with the dispenser, spout or liquid supply line, as to permit its replacement and/or maintenance when needed.

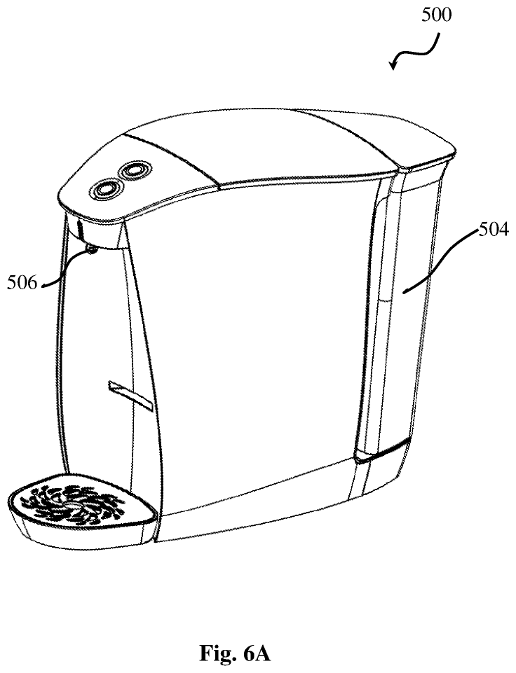

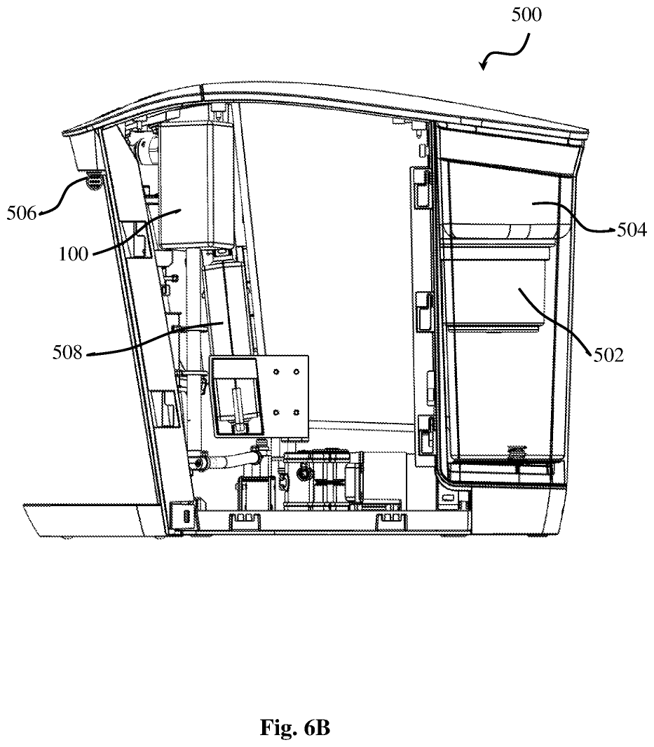

For example, as seen in FIGS. 6A-6B, an exemplary water dispenser 500 is shown. Water dispenser 500 comprises one or more water treatment cartridges 502 (such as a filtering unit or a unit that removes various contaminants from the water, and/or adds various additives to the water), that in this specific example receives water to be treated from water reservoir 504. It is to be noted that instead of reservoir 504 can be replaced by a liquid-communication to a running water source (such as a water supply line, not shown). After treatment by the water treatment cartridges 502, water is pumped through the UV-radiation disinfection module, e.g. module 100 (or alternatively modules 200, 200′, 300 or 400), for UV disinfection, and from there out of the dispensing nozzle 506 for dispensing to the user. In case heated water needs to be dispensed, water can be heated through heating unit 508 before dispensing to the user.

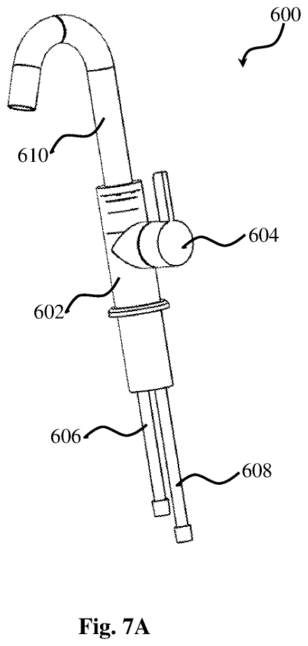

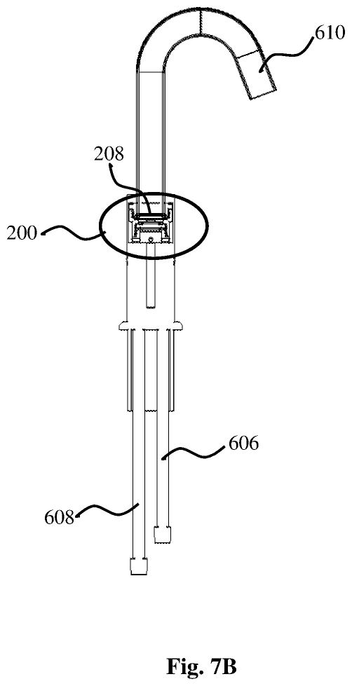

Alternatively, the disinfection module may be an integral part of a spout unit. An exemplary spout unit in which the disinfection device is integrally formed with a spout is shown in FIGS. 7A-7B. Spout unit 600 comprises a unit body 602, which (as can better be seen in FIG. 7B) houses the disinfection module (100, 200, 200′, 300, or 400). The unit also comprises a user-operable lever mechanism 604 to permit and control liquid (i.e. water) flow through the unit. Unit 600 is being fed liquid through one or more supply lines, in this case two supply lines 606 and 608 for supplying hot and cold water to the unit. The housing is integrally formed with a spout 610, which is in liquid communication with the outlet 208 of the disinfection device, as can be seen in FIG. 7B.

It is to be understood that although described as separate embodiments, various combinations of the embodiments described herein are contemplated and are within the scope of this disclosure. For example, one or more quartz tubes can be utilized together with the quartz horizontal plate in order to maximize radiation treatment efficiency.

As noted, the disinfection device of this disclosure may be linkable to various end units, such as liquid dispensers and spouts for dispensing disinfected liquid. The device may be configured for temporary association with the dispenser, spout or liquid supply line, as to permit its replacement and/or maintenance when needed.

1.-54. (canceled)

55. A UV-radiation disinfection module for disinfecting water, the module comprises:
at least one disinfection chamber extending along a longitudinal axis, and having at least one water inlet and at least one treated water outlet with a water flow path defined therebetween, and
a UV radiation unit, comprising at least one UV radiation source, and one or more lenses positioned between the UV radiation source and the disinfection chamber for focusing UV radiation from the UV radiation source into the disinfection chamber, at least one of said one or more lenses being a user-removable lens, removably received in the UV radiation unit,
the disinfection chamber being configured to permit exposure of said water to UV radiation emitted from the UV radiation source during flow of water along the flow path.

56. The module of claim 55, wherein said removable lens is displaceable along an extraction axis, perpendicular to the longitudinal axis, between a functional position in which it is received within the UV radiation unit and positioned between the UV radiation source and the disinfection chamber, and a non-functional position, in which it is extracted from the UV radiation unit.

57. The module of claim 55, wherein said removable lens has an optical magnification of between about 0% to 500%.

58. The module of claim 55, further comprising at least one stationary lens, positioned between said user-removable lens and said UV radiation source.

59. The module of claim 55, wherein the at least one water inlet being positioned proximal to a first end of the disinfection chamber and the at least one treated water outlet being positioned proximal to the opposite second end of the disinfection chamber.

60. The module of claim 5, wherein the at least one UV radiation unit being positioned at said second end, and wherein said first end is fitted with one or more mirror elements for reflecting UV radiation into the disinfection chamber.

61. The module of claim 55, wherein the disinfection chamber is generally cylindrical, and having one or more narrowing sections.

62. The module of claim 55, wherein the disinfection chamber is cylindrical, and having an axial hollow bore formed out of co-axial frustoconical cavities, consecutively arranged along the longitudinal axis, with their narrow ends being integral one with the other to form a narrowing point, wherein the focal point of the removable lens coincides with the point of the narrowing point.

63. The module of claim 55, wherein the disinfection chamber comprises a UV-reflecting liner coating at least a portion of the internal surface of the disinfection chamber.

64. The module of claim 55, wherein the disinfection chamber encases an internal sleeve, co-axial with the disinfection chamber, wherein the internal sleeve has the shape of an hourglass to form a narrowing point.

65. The module of claim 55, wherein the disinfection chamber is detachably attached to the UV radiation unit.

66. The module of claim 55, wherein the UV radiation unit comprises at least one fluid-flow passage configured to pass a cooling fluid through the unit.

67. The module of claim 55, wherein the UV radiation source is a UV-LED.

68. The module of claim 55, wherein the UV radiation unit and the disinfection chamber are integral one with the other and extending along a longitudinal axis defined therebetween, and a liquid conduit forming liquid communication between the UV radiation unit and the disinfection chamber,
the UV radiation unit further comprises a housing with a water inlet located at a bottom section of the housing and a water outlet located at a side wall of the housing and forming a first liquid flow path therebetween, and a UV radiation source assembly housed within the housing,
formed within the UV radiation source assembly is a liquid sealed chamber that housing said at least one UV radiation sources,
the at least one UV radiation sources being coupled to a heat sink positioned at the bottom of the liquid sealed chamber, such that the heat sink is thermally coupled to the first flow path thereby heat is removed from the heat sink by the water flowing through the first flow path;
the disinfection chamber having a chamber inlet and a chamber outlet defining a second liquid flow path therebetween, and the disinfection chamber having an internal face along the second liquid flow path with at least a portion thereof covered by a reflective surface such that UV radiation from the UV radiation source is reflected by the reflective surface into the water flowing in the second flow path thereby disinfecting the water;
the liquid conduit formed between the water outlet of the UV radiation unit and the chamber inlet of the disinfection chamber, thereby forming the liquid communication between the radiation unit and the disinfection chamber.

69. The module of claim 68, wherein the internal face of the disinfection chamber is lined with a radiation-transmissive lining.

70. The module of claim 55, wherein the water inlet is configured to establish liquid communication with a water source.

71. The module of claim 55, wherein the disinfection chamber outlet is configured to establish liquid communication with a water dispenser or a dispensing outlet of a water dispenser.

72. The module of claim 55, wherein the disinfection chamber outlet is linkable to a spout.

73. A beverage dispenser comprising at least one UV-radiation disinfection module of claim 55.

74. A water spout unit for dispensing UV-disinfected water, the spout unit comprising a UV-radiation disinfection module having a water module inlet and a water module outlet, and a spout linked to the water module outlet,
the UV-radiation disinfection module comprising a UV radiation unit and a disinfection chamber integral therewith and extending along a longitudinal axis defined therebetween, and a water conduit forming a fluid communication between the UV radiation unit and the disinfection chamber,
the UV radiation unit comprises a housing with a water inlet located at a bottom section of the housing and in liquid communication with the module water inlet, and a water outlet located at a side wall of the housing and forming a first liquid flow path therebetween, and a UV radiation source assembly housed within the housing,
formed within the UV radiation source assembly is a liquid sealed chamber that houses one or more UV radiation sources, the one or more UV radiation sources being coupled to a heat sink positioned at the bottom of the liquid sealed chamber, such that the heat sink is thermally coupled to the first flow path thereby heat is removed from the heat sink by the water flowing through the first flow path, the liquid sealed chamber and the disinfection chamber having at least one common, UV radiation-transmissive wall, such that UV radiation from the one or more radiation source is transmitted into the disinfecting chamber;
the disinfection chamber having a chamber inlet and a chamber outlet defining a second fluid flow path therebetween, and the disinfection chamber having an internal face along the second liquid flow path with at least a portion thereof covered by a reflective surface such that radiation from the UV radiation source is reflected by the reflective surface into the water flowing in the second flow path thereby disinfecting the water;
the water conduit formed between the water outlet of the UV radiation unit and the chamber inlet of the disinfection chamber, thereby forming the liquid communication between the radiation unit and the disinfection chamber,
wherein the UV radiation-transmissive wall is a user-removable lens.
